(19) United States
(12) Patent Application Publication
(10) Pub. No.: US 2018/0032586 A1
(43) Pub. Date: Feb. 1, 2018

(54) SCALABLE RESERVOIR SAMPLING

(71) Applicant: Futurewei Technologies, Inc., Plano, TX (US)

(72) Inventors: Jiangsheng Yu, San Jose, CA (US); Hui Zang, Cupertino, CA (US)

(21) Appl. No.: 15/224,511

(22) Filed: Jul. 30, 2016

(51) Int. Cl. G06F 17/30; G06N 7/00; G06F 7/58

(52) U.S. Cl. CPC G06F 17/30536; G06F 7/582; G06N 7/005

(57) ABSTRACT

A sampling method includes responsive to a sequence of elements, of length n, determining a number of samples k as a step function k(n) of the number of elements, and selecting k(n) samples from the n elements as a sample list.

### FIELD OF THE INVENTION

The present disclosure is related to creating a reservoir from a sample, and in particular to creating a reservoir from a sample having an unknown size.

### BACKGROUND

Reservoir sampling is a family of randomized algorithms for randomly choosing a sample of k items from a list containing n items, where n is either a very large or unknown number. Typically n is large enough that the list does not fit into main memory of computing resources utilized to perform the sampling. In reservoir sampling, a sequence of samples having n elements is sampled to obtain a reservoir of k elements.

Suppose a sequence of items is obtained, one at a time. Further suppose k=1. A single item may be kept in memory, and it should be selected at random from the sequence. If the total number of items (n) is known, then the solution is easy: select an index i between 1 and n with equal probability, and keep the i^{th} element. The problem is that n may not be known in advance. One prior solution called “reservoir sampling” includes keeping the first item in memory and when the i^{th} item arrives, where i is >1, with a probability of 1/i, keep the new i^{th} item instead of the current item. With a probability of 1-1/i, keep the current item and discard the new item. This process is referred to as replacement, and results in each item being kept with a probability of 1/n. In replacement, items are replaced with gradually decreasing probability. When the solution has finished processing, each item in the list has an equal probability of having been selected for the reservoir.

In an alternative method, a random sort-based algorithm uses a priority queue data structure. The random sort based algorithm assigns random numbers as keys to each item and maintain k items with minimum value for keys. In essence, this is equivalent to assigning a random number to each item as a key, sorting items using the keys, and taking the top k items.

### SUMMARY

A sampling method includes responsive to a sequence of elements, n, from a data set stored on a non-transitory computer readable storage device, determining a number of samples k as a step function k(n) of the number of elements, and selecting k(n) samples from the n elements as a sample list.

A device includes a non-transitory memory storage comprising instructions and one or more processors in communication with the memory storage. The one or more processors execute the instructions to, responsive to a sequence of elements, n, from a data set stored on a non-transitory computer readable storage device, determine a number of samples k as a step function k(n) of the number of elements, and select k(n) samples from the n elements as a reservoir of samples.

A non-transitory computer-readable media storing computer instructions for sampling a data set, that when executed by one or more processors, cause the one or more processors to perform the steps of, responsive to a sequence of elements, n, from a data set stored on a non-transitory computer readable storage device, determining a number of samples k as a step function k(n) of the number of elements, and selecting k(n) samples from the n elements as a reservoir of samples.

Various examples are now described. In example 1, a method includes, responsive to a sequence of elements of length n, from a data set stored on a non-transitory computer readable storage device, determining a number of samples k as a step function k(n) of the number of elements, and selecting k(n) samples from the n elements as a sample list.

Example 2 includes the sampling method of example 1 wherein the number of selected samples, k(n), increases in steps with increasing elements, n, where k(n) is always less than n.

Example 3 includes he sampling method of any of examples 1-2 wherein the step function k(n) comprises:

$$k ( n ) = \{ \begin{matrix}{k}_{1} & if {n}_{0} < n \leq {n}_{1} and {n}_{0} = 0 & \\ {k}_{2} & if {n}_{1} < n \leq {n}_{2} & \\ ⋮ & & \\ {k}_{i} & if {n}_{i - 1} < n \leq {n}_{i} & \\ ⋮ & & \end{matrix}$$

Example 4 includes the sampling method of any of examples 1-3 wherein the step function comprises a logarithmic function of n, where n is greater than 1.

Example 5 includes the sampling method of any of examples 1-4 wherein the step function kθ(n) is defined by kθ(1)=1 and kθ(n)=[min{n, logθ(n)}], where θ>1 and n>1.

Example 6 includes the sampling method of any of examples 1-5 wherein the method starts by assuming n is less than n1, when the n1th element is encountered, the method increases the assumed value of n to be n2, when the assumption of value of n is updated, the corresponding k(n) is updated, wherein the sample list transitions from a full state to a non-full state when new elements are observed, and wherein newly encountered elements are added to the sample list when the sample list is not full.

Example 7 includes the sampling method of any of examples 1-6 wherein at most one randomly selected sample is replaced with a newly encountered element, when the sample list is full.

Example 8 includes the sampling method of any of examples 1-7 wherein responsive to increasing the number of selected samples from kold to knew due to the observation of new elements, newly encountered data elements are added as newly selected samples to the sample list until the sample list length reaches knew.

Example 9 includes the sampling method of any of examples 1-8 wherein the sampling is performed by executing a function wherein one element in the sample list r1, . . . rk is updated by a newly encountered element c, the j^{th} element in the sequence, using a random number generated via a uniform distribution over 1, 2, . . . , j, where j>k:

```
updating_reservoir <-function (r[1:k],j){
      ## randomly selecting an index from 1:j
      idx <- random (1:j)
      if (idx<= k){
            r[idx] <-x[j]
      }
      return(r[1:k])
}.
```

In example 10, a device includes a non-transitory memory storage comprising instructions and one or more processors in communication with the memory storage, wherein the one or more processors execute the instructions to: responsive to a sequence of elements of length n, from a data set stored on a non-transitory computer readable storage device, determine a number of samples k as a step function k(n) of the number of elements, and select k(n) samples from the n elements as a list of samples.

Example 11 includes the device of example 10 wherein the step function k(n) comprises:

$$k ( n ) = \{ \begin{matrix}{k}_{1} & if {n}_{0} < n \leq {n}_{1} and {n}_{0} = 0 & \\ {k}_{2} & if {n}_{1} < n \leq {n}_{2} & \\ ⋮ & & \\ {k}_{i} & if {n}_{i - 1} < n \leq {n}_{i} & \\ ⋮ & & \end{matrix}$$

Example 12 includes the device of any of examples 10-11 wherein the step function kθ(n) is defined by kθ(1)=1 and kθ(n)=[min{n, logθ(n)}], where θ>1 and n>1.

Example 13 includes the device of any of examples 10-12 wherein newly encountered elements are added to the sample list when the sample list is not full.

Example 14 includes the device of any of examples 10-13 wherein at most one randomly selected sample is replaced with a newly encountered element, when the sample list is full.

Example 15 includes the device of any of examples 10-14 wherein responsive to increasing the number of selected samples from kold to knew due to the observation of new elements, newly encountered data elements are added as newly selected samples to the sample list until the sample list length reaches knew.

Example 16 includes the device of any of examples 10-15 wherein the sampling is performed by executing a function wherein one element in a sequence of r1, . . . rk is updated by a newly encountered element c, the j^{th} element in the sequence, using a random number generated via a uniform distribution over 1, 2, . . . , j, where j>k:

```
updating_reservoir <-function (r[1:k],j){
      ## randomly selecting an index from 1:j
      idx <- random (1:j)
      if (idx<= k){
            r[idx] <-x[j]
      }
      return(r[1:k])
}.
```

In example 17, a non-transitory computer-readable media storing computer instructions for sampling a data set, that when executed by one or more processors, cause the one or more processors to perform the steps of: responsive to a sequence of elements, n, from a data set stored on a non-transitory computer readable storage device, determining a number of samples k as a step function k(n) of the number of elements, and selecting k(n) samples from the n elements as a list of samples.

Example 18 includes the non-transitory computer-readable media of example 17 wherein the step function k(n) comprises:

$$k ( n ) = \{ \begin{matrix}{k}_{1} & if {n}_{0} < n \leq {n}_{1} and {n}_{0} = 0 & \\ {k}_{2} & if {n}_{1} < n \leq {n}_{2} & \\ ⋮ & & \\ {k}_{i} & if {n}_{i - 1} < n \leq {n}_{i} & \\ ⋮ & & \end{matrix}$$

Example 19 includes the non-transitory computer-readable media of any of examples 17-18 wherein the step function kθ(n) is defined by kθ(1)=1 and kθ(n)=[min{n, logθ(n)}], where θ>1 and n>1.

Example 20 includes the non-transitory computer-readable media of any of examples 17-19 wherein newly encountered elements are added to the sample list when the sample list is not full, at most one randomly selected sample is replaced with a newly encountered element, when the sample list is full, wherein responsive to increasing the number of selected samples from k_{old} to k_{new} due to observation of new elements, newly encountered data elements are added as newly selected samples to the sample list until the sample list length reaches k_{new}., and wherein the random sampling is performed by executing a function wherein one element in a sequence of r₁, . . . rₖ is updated by a newly encountered element c, the j^{th} element in the sequence, using a random number generated via a uniform distribution over 1, 2, . . . , j, where j>k:

```
updating_reservoir <-function (r[1:k],j){
      ## randomly selecting an index from 1:j
      idx <- random (1:j)
      if (idx<= k){
            r[idx] <-x[j]
      }
      return(r[1:k])
}.
```

### BRIEF DESCRIPTION OF THE DRAWINGS

FIG. 1 is a graph illustrating a step function to determine a reservoir size, providing scalable reservoir sampling according to an example embodiment.

FIG. 2 is a graph illustrating a logarithmic function to determine a reservoir size according to an example embodiment.

FIG. 3 is a flowchart illustrating a method of determining a number of samples and obtaining the samples according to an example embodiment.

FIG. 4 is a flowchart illustrating a method of selecting a scalable number of samples, k(n), based on the number of elements, n, in the data set according to an example embodiment.

FIGS. 5A, 5B, 5C, 5D, 5E, and 5F illustrate histograms of distinct ranks of samples obtained according to an example embodiment.

FIGS. 6A, 6B, 6C, 6D, 6D, 6E, and 6F are histograms that provide a comparison between scalable reservoir sampling illustrated in FIGS. 5A, 5B, 5C, 5D, 5D, and 5F and classical reservoir sampling according to an example embodiment.

FIG. 7 is a block diagram illustrating circuitry for clients, servers, and cloud based resources for implementing algorithms and performing methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

A computer implemented method of reservoir sampling extracts k elements without replacement from a sequence of observations x₁, . . . , xₙ, where the sample size n is unknown. The reservoir size k is an increasing function of n.

In one embodiment, a scalable reservoir sampling algorithm utilizes a step function to determine a value of k based on the number of elements, n, of the data set as the elements are encountered during sampling. The more data encountered, the larger the sample size, k, grows. The values of k associated with each step may be defined by a user, allowing the user to obtain the accuracy desired for the sampling.

Data sets, such as data collected with respect to cellular phone usage, can be very large. Examples of information collected from each cell phone may include where and when a call occurred, the parties on the call, websites visited, and other information. The data set may quickly become too large in fact to simply place the data in the main memory of a computer system and sample it, such that each individual element of the data set has an equal chance of being selected for the sample. Further, the size of the data set may be unknown, or even changing while sampling is being performed.

One prior method of sampling an unknown size data set involves the use of replacement of previously selected samples with new samples. A current item or sample may already have been selected and placed in memory. When the i^{th} item arrives, where i is >1, with a probability of 1/i, the new i^{th} item is kept instead of the current item. In other words, the new item replaces the current item in the list. With a probability of 1-1/i, keep the current item and discard the new item. Such a replacement action results in each item being kept with a probability of 1/n. In replacement, items are replaced with gradually decreasing probability. When the solution has finished processing, each item in the list has an equal probability of having been selected for the reservoir. However, the use of replacement in such a manner consumes significant processing resources and is not very efficient. Further, for very large data sets, keeping the sample size constant reduces the likelihood of obtaining a sample that is highly representative of the entire data set.

In one embodiment, an updating reservoir function may be used to determine whether or not to update one element in a sequence of r₁, . . . , rₖ by a newly encountered element c, the j^{th} element in the sequence, using a random number generated via a uniform distribution over 1, 2, . . . , j, where j>k. If the randomly selected index, idx is less than k, x[j] is used to replace the element, r, in the sequence.

```
updating_reservoir <- function(r[1:k],j){
      ## randomly selecting an index from 1:j
      idx <- random(1:j)
      if (idx <= k){
            r[idx] <- x[j]
      }
      return(r[1:k])
}
```

A reservoir algorithm that draws a fixed number of samples, k, may be used to update the reservoir, also referred to as a sample list, as follows. For convenience, the output of k-reservoir sampling of x₁, . . . , xₙ by is denoted as R(x₁, . . . , xₙ; k) or simply R(x; k). Given k and a sequence x₁, . . . , xₙ (denoted by x), without replacement, k elements are randomly selected. If n≧k, then r₁=x₁, . . . , rₙ=xₙ are returned. If n>k, then the above function is called, returning updating_reservoir(R(x₁, . . . , xₙ₋₁; k), xₙ, n).

In one embodiment, the step function to determine k is defined as step function k(n) as follows.

$$k ( n ) = \{ \begin{matrix}{k}_{1} & if {n}_{0} < n \leq {n}_{1} and {n}_{0} = 0 & \\ {k}_{2} & if {n}_{1} < n \leq {n}_{2} & \\ ⋮ & & \\ {k}_{i} & if {n}_{i - 1} < n \leq {n}_{i} & \\ ⋮ & & \end{matrix} \qquad ( 1 )$$

In one embodiment, it is assumed that kᵢ-kᵢ₋₁≦nᵢ-nᵢ₋₁ where k₀=n₀=0 and i=1, 2, . . . . In other words, there are more elements of the data set than the increase in the number of samples at each step. In addition, kᵢ≦nᵢ. In general, kᵢ-kᵢ₋₁<<nᵢ-nᵢ₋₁ for large i.

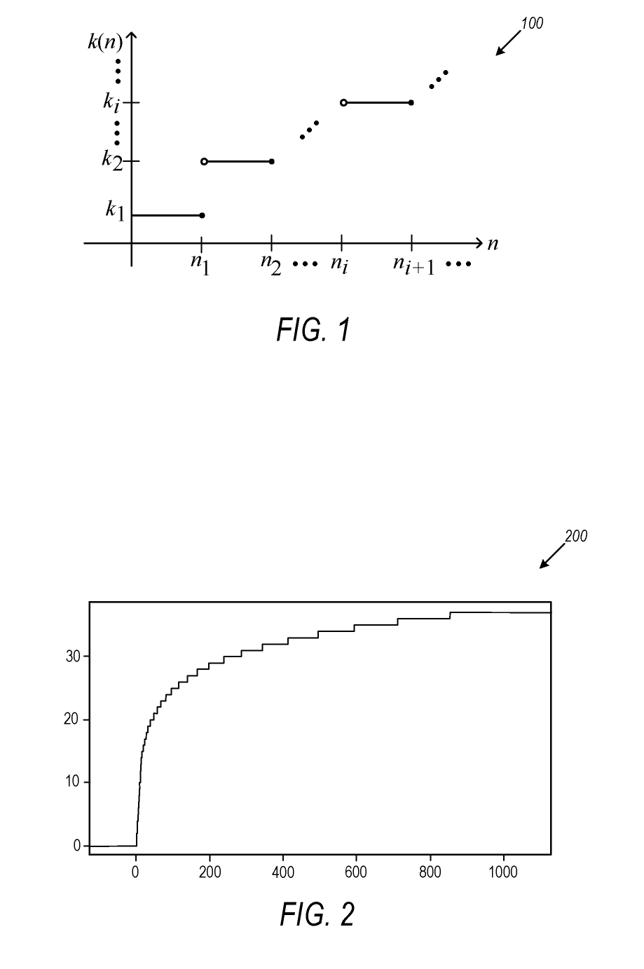

FIG. 1 is a graph illustrating the step function at 100 defined by equation (1). Step function 100 may be used to determine the reservoir size, providing scalable reservoir sampling.

In a further embodiment, a step function k_{θ}(n) is defined by k_{θ}(1)=1 and k_{θ}(n)=[min{n, log_{θ}(n)}], where θ>1 and n>1. For instance, the step function k_{1.2}(n) is illustrated at 200 in FIG. 2, where step function k(n)=[min{n, log_{1.2}(n)}] for n>1. FIG. 2 is a graph illustrating a logarithmic function to determine a reservoir size according to an example embodiment.

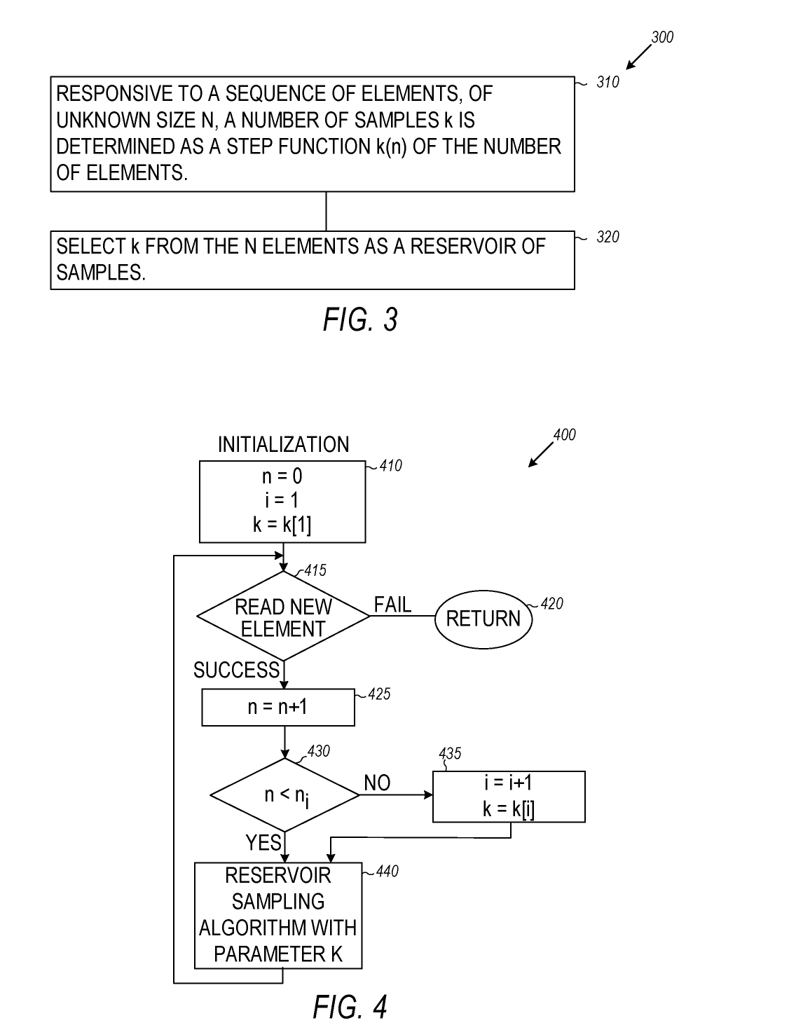

FIG. 3 is a flowchart illustrating a method 300 of determining a number of samples to obtain, the sample list, as a function of the number of elements, n, in a data set. At 310, responsive to a sequence of elements, n, from a data set stored on a non-transitory computer readable storage device, a number of samples k is determined as a step function k(n) of the number of elements. At 320, k(n) samples are selected from the n elements as a reservoir of samples.

FIG. 4 is a flowchart illustrating a method 400 of selecting a scalable number of samples, k(n) based on the number of elements, n, in the data set. In general, newly encountered elements are added to the sample list when the sample list is not full. At most, one randomly selected sample is replaced with a newly encountered element, when the sample list is full. Responsive to increasing the number of selected samples from k_{old} to k_{new} due to the sequence of elements increasing, newly encountered data elements are added as newly selected samples to the sample list until the sample list length reaches k_{new}.

In method 400 at 410, a number of elements, n, in a sequence x₁, . . . , xₙ is initialized to 0. A variable, i, is initialized to 1, and a number of samples, k, is initialized to k[1], the number of samples at the first step of the step function k(n). At a decision block 415, a new element is read. If there is no new element from the samples to read, method 400 returns at 420. If an element is successfully read at 415, n is incremented by 1 at 425, and if the newly incremented n is not less than nᵢ, i is incremented and k is set to k[i] at 435 to update the number of samples. A reservoir sampling algorithm, such as the above described updating reservoir function, is then performed at 440 to replace an element with the currently read element or simply add the element as a sample if the number of samples is still less than k. Note that if n is less than nᵢ, at 430, the reservoir sampling algorithm 440 is also performed without updating k. Processing then returns to 415 to read a new element. By expanding the classic reservoir sampling algorithm into a series of reservoir sampling processes with changing k values, each element still ends up with an equal chance of being selected as a sample, even though the number of elements may not be known at the beginning of the sampling.

In one example, scalable reservoir sampling of the sequence 1, 2, . . . , 10³ was performed using the step function 200 and method 400, 37 samples were extracted without replacement in one random experiment. The following samples were extracted for example: 64, 115, 165, 193, 224, 238, 249, 277, 285, 291, 342, 343, 357, 371, 411, 423, 425, 437, 493, 516, 518, 567, 591, 596, 605, 614, 638, 647, 672, 709, 712, 726, 775, 851, 908, 977, 980.

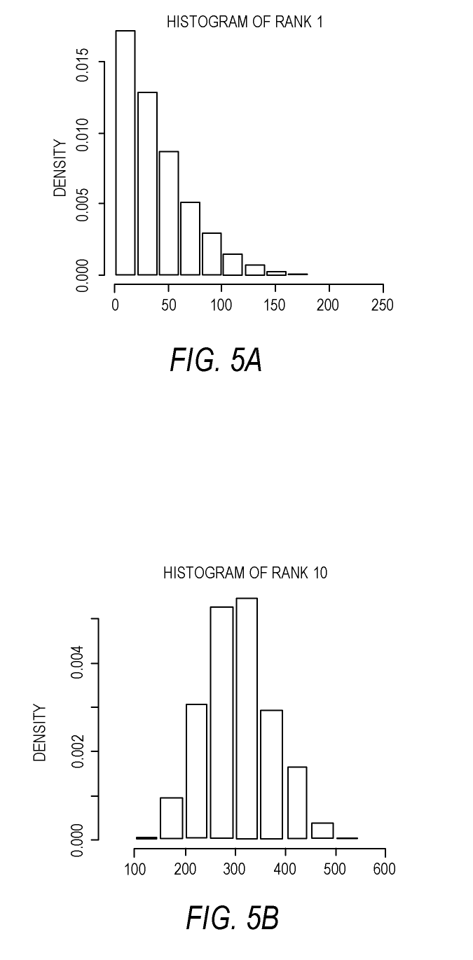

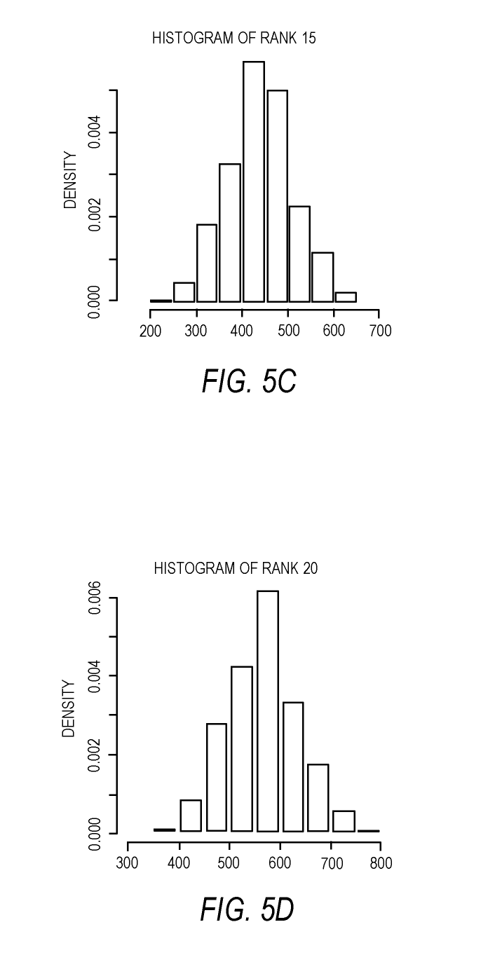

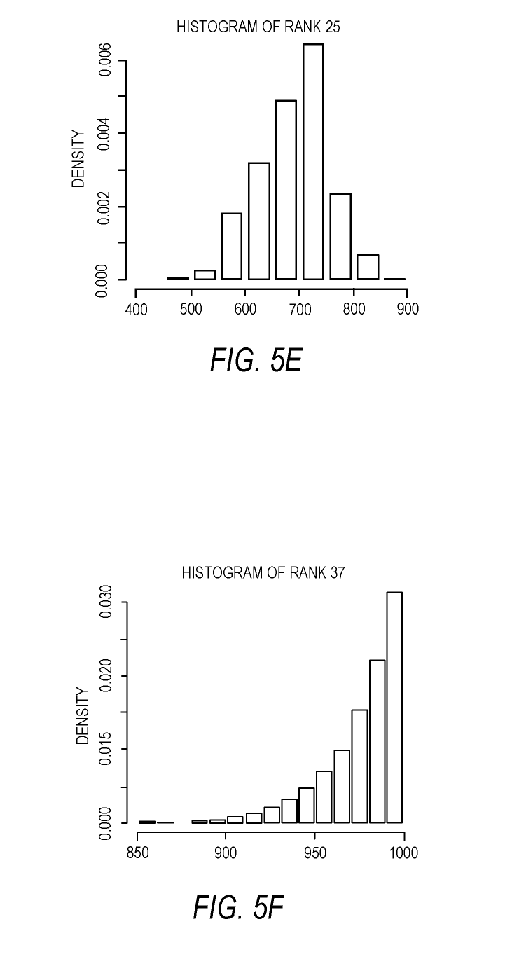

The final results were sorted. This random experiment was repeated 10⁴ (i.e., 10000) times on this sequence independently to generate histograms of distinct ranks of the final sorted lists. FIGS. 5A, 5B, 5C, 5D, 5E, and 5F illustrate histograms of distinct ranks that were obtained according to embodiments shown and described herein. Distinct ranks refer to samples at various ranks of the sorted results as seen in each of the figures. For example, FIG. 5A illustrates the histogram of a rank of 1, pulling a first sample from the sorted lists. FIGS. 5B-5F are of ranks 10, 15, 20, 25, and 37 respectively. The y axis is a measure of density, and the x axis are values of the elements at the corresponding rank. As seen in the progression of figures, the lowest ranking elements had lower values and the highest ranking elements had higher values as the x axis range of values increased.

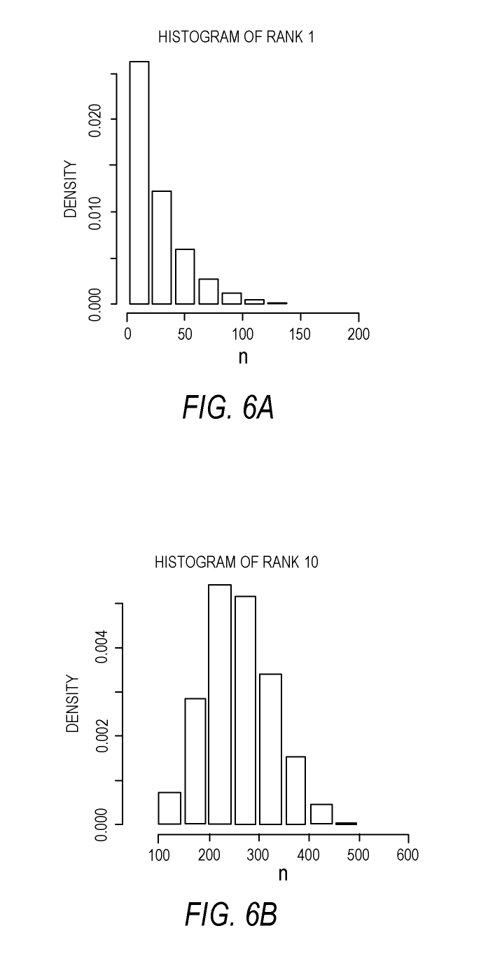

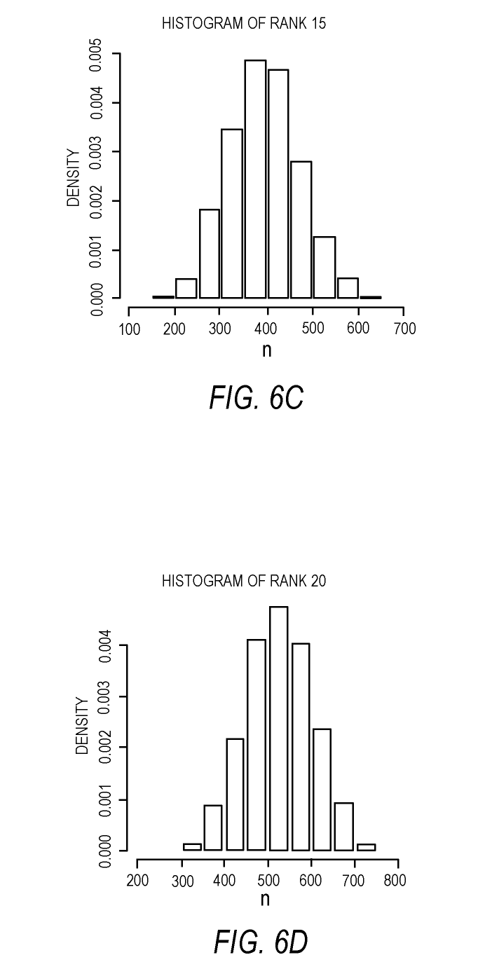

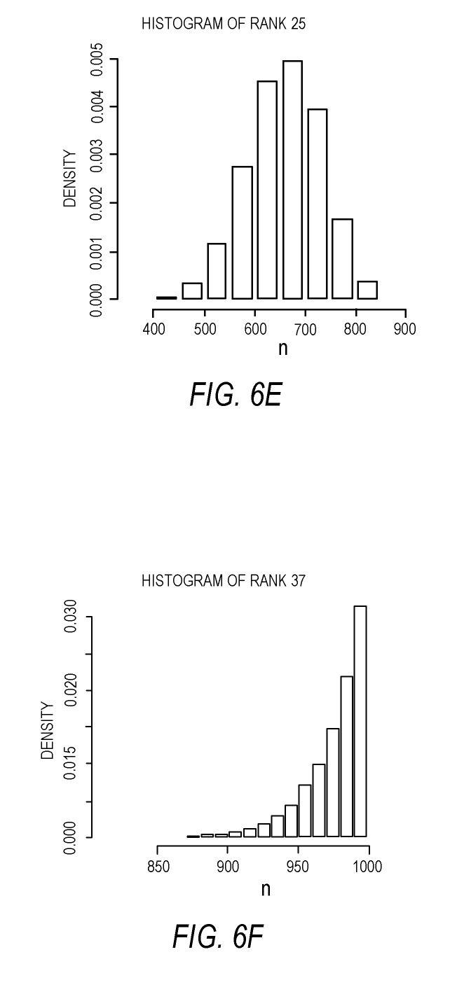

FIGS. 6A, 6B, 6C, 6D, 6D, and 6F are histograms of distinct ranks of sampled lists obtained via the reservoir sampling algorithm, using a same reservoir size of 37, and repeating the classical reservoir sampling process 10⁴ times independently. The figures have the same rank values as the corresponding figure numbers 5A-F. FIGS. 5A-F and FIGS. 6A-F provide a comparison between scalable reservoir sampling and classical reservoir sampling. FIGS. 5A-F and 6A-F show that the scalable reservoir sampling, as shown and described herein, is a natural extension of reservoir sampling without pre-defining the reservoir size, as the results are comparable as can be seen by observing that the bars in each corresponding figure appear fairly equally sized.

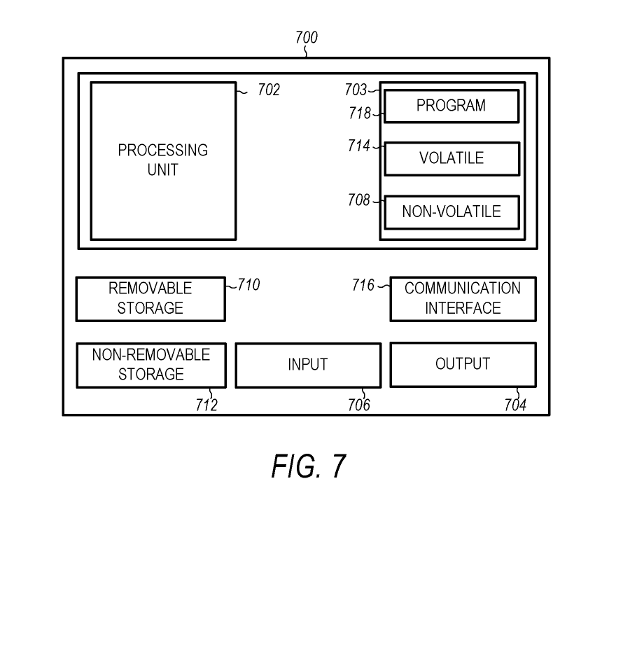

FIG. 7 is a block diagram illustrating circuitry for clients, servers, and cloud based resources for implementing algorithms and performing methods according to example embodiments. All components need not be used in various embodiments. For example, the clients, servers, and network resources may each use a different set of components, or in the case of servers for example, larger storage devices.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, or other computing device including the same or similar elements as illustrated and described with regard to FIG. 7. Devices, such as smartphones, tablets, and smartwatches, are generally collectively referred to as mobile devices or user equipment. Further, although the various data storage elements are illustrated as part of the computer 700, the storage may also or alternatively include cloud-based storage accessible via a network, such as the Internet or server based storage.

Memory 703 may include volatile memory 714 and/or non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input 706, output 704, and a communication interface 716. Output 704 may include a display device, such as a touchscreen, that also may serve as an input device. The input 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common network node, or the like. The communication interface 716 may include a Local Area Network (LAN), a Wide Area Network (WAN), cellular, WiFi, Bluetooth, or other networks.

Computer-readable instructions stored on a computer-readable medium are executable by the processing unit 702 of the computer 700. A hard drive, CD-ROM, and RAM are some examples of articles including a non-transitory computer-readable medium such as a storage device. The terms computer-readable medium and storage device do not include carrier waves to the extent carrier waves are deemed too transitory. For example, a computer program 718 for performing an access control check for data access and/or for doing an operation on one of the servers in a component object model (COM) based system may be included on a CD-ROM and loaded from the CD-ROM to a hard drive.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A sampling method comprising:
responsive to a sequence of elements of length n, from a data set stored on a non-transitory computer readable storage device, determining a number of samples k as a step function k(n) of the number of elements; and
selecting k(n) samples from the n elements as a sample list.

2. The sampling method of claim 1 wherein the number of selected samples, k(n), increases in steps with increasing elements, n, where k(n) is always less than n.

3. The sampling method of claim 1 wherein the step function k(n) comprises:
$$k ( n ) = \{ \begin{matrix}{k}_{1} & if {n}_{0} < n \leq {n}_{1} and {n}_{0} = 0 & \\ {k}_{2} & if {n}_{1} < n \leq {n}_{2} & \\ ⋮ & & \\ {k}_{i} & if {n}_{i - 1} < n \leq {n}_{i} & \\ ⋮ & & \end{matrix} .$$

4. The sampling method of claim 1 wherein the step function comprises a logarithmic function of n, where n is greater than 1.

5. The sampling method of claim 1 wherein the step function k_{θ}(n) is defined by k_{θ}(1)=1 and k_{θ}(n)=[min{n, log_{θ}(n)}], where θ>1 and n>1.

6. The sampling method of claim 1 wherein the method starts by assuming n is less than n1, when the n1^{th} element is encountered, the method increases the assumed value of n to be n2, when the assumption of value of n is updated, the corresponding k(n) is updated, wherein the sample list transitions from a full state to a non-full state when new elements are observed, and wherein newly encountered elements are added to the sample list when the sample list is not full.

7. The sampling method of claim 1 wherein at most one randomly selected sample is replaced with a newly encountered element, when the sample list is full.

8. The sampling method of claim 1 wherein responsive to increasing the number of selected samples from k_{old} to k_{new} due to the observation of new elements, newly encountered data elements are added as newly selected samples to the sample list until the sample list length reaches knew.

9. The sampling method of claim 1 wherein the sampling is performed by executing a function wherein one element in the sample list r₁, . . . rₖ is updated by a newly encountered element c, the j^{th} element in the sequence, using a random number generated via a uniform distribution over 1, 2, . . . , j, where j>k:
```
updating_reservoir <-function (r[1:k],j){
      ## randomly selecting an index from 1:j
      idx <- random (1:j)
      if (idx<= k){
            r[idx] <-x[j]
      }
      return(r[1:k])
}.
```

10. A device comprising:
a non-transitory memory storage comprising instructions; and
one or more processors in communication with the memory storage, wherein the one or more processors execute the instructions to:
responsive to a sequence of elements of length n, from a data set stored on a non-transitory computer readable storage device, determine a number of samples k as a step function k(n) of the number of elements; and
select k(n) samples from the n elements as a list of samples.

11. The device of claim 10 wherein the step function k(n) comprises:
$$k ( n ) = \{ \begin{matrix}{k}_{1} & if {n}_{0} < n \leq {n}_{1} and {n}_{0} = 0 & \\ {k}_{2} & if {n}_{1} < n \leq {n}_{2} & \\ ⋮ & & \\ {k}_{i} & if {n}_{i - 1} < n \leq {n}_{i} & \\ ⋮ & & \end{matrix} .$$

12. The device of claim 10 wherein the step function k_{θ}(n) is defined by k_{θ}(1)=1 and k_{θ}(n)=[min{n, log_{θ}(n)}], where θ>1 and n>1.

13. The device of claim 10 wherein newly encountered elements are added to the sample list when the sample list is not full.

14. The device of claim 10 wherein at most one randomly selected sample is replaced with a newly encountered element, when the sample list is full.

15. The device of claim 10 wherein responsive to increasing the number of selected samples from k_{old} to k_{new} due to the observation of new elements, newly encountered data elements are added as newly selected samples to the sample list until the sample list length reaches k_{new}.

16. The device of claim 10 wherein the sampling is performed by executing a function wherein one element in a sequence of r₁, . . . rₖ is updated by a newly encountered element c, the j^{th} element in the sequence, using a random number generated via a uniform distribution over 1, 2, . . . , j, where j>k:
```
updating_reservoir <-function (r[1:k],j){
      ## randomly selecting an index from 1:j
      idx <- random (1:j)
      if (idx<= k){
            r[idx] <-x[j]
      }
      return(r[1:k])
}.
```

17. A non-transitory computer-readable media storing computer instructions for sampling a data set that, when executed by one or more processors, cause the one or more processors to perform the steps of:
responsive to a sequence of elements, n, from a data set stored on a non-transitory computer readable storage device, determining a number of samples k as a step function k(n) of the number of elements; and
selecting k(n) samples from the n elements as a list of samples.

18. The non-transitory computer-readable media of claim 17 wherein the step function k(n) comprises:
$$k ( n ) = \{ \begin{matrix}{k}_{1} & if {n}_{0} < n \leq {n}_{1} and {n}_{0} = 0 & \\ {k}_{2} & if {n}_{1} < n \leq {n}_{2} & \\ ⋮ & & \\ {k}_{i} & if {n}_{i - 1} < n \leq {n}_{i} & \\ ⋮ & & \end{matrix} .$$

19. The non-transitory computer-readable media of claim 17 wherein the step function k_{θ}(n) is defined by k_{θ}(1)=1 and k_{θ}(n)=[min{n, log_{θ}(n)}], where θ>1 and n>1.

20. The non-transitory computer-readable media of claim 17 wherein newly encountered elements are added to the sample list when the sample list is not full, at most one randomly selected sample is replaced with a newly encountered element, when the sample list is full, wherein responsive to increasing the number of selected samples from k_{old} to k_{new} due to observation of new elements, newly encountered data elements are added as newly selected samples to the sample list until the sample list length reaches k_{new}, and wherein the random sampling is performed by executing a function wherein one element in a sequence of r₁, . . . rₖ is updated by a newly encountered element c, the j^{th} element in the sequence, using a random number generated via a uniform distribution over 1, 2, . . . , j, where j>k:
```
updating_reservoir <-function (r[1:k],j){
      ## randomly selecting an index from 1:j
      idx <- random (1:j)
      if (idx<= k){
            r[idx] <-x[j]
      }
      return(r[1:k])
}.
```
